(19) United States
(12) Patent Application Publication
(10) Pub. No.: US 2015/0002115 A1
(43) Pub. Date: Jan. 1, 2015

(54) SERIES-CAPACITOR BUCK CONVERTER MULTIPHASE CONTROLLER

(71) Applicant: Texas Instruments Incorporated, Dallas, TX (US)

(72) Inventors: Pradeep S. Shenoy, Richardson, TX (US); Michael G. Amaro, Naperville, IL (US)

(21) Appl. No.: 14/319,964

(22) Filed: Jun. 30, 2014

Related U.S. Application Data
(60) Provisional application No. 61/841,770, filed on Jul. 1, 2013.

(51) Int. Cl. H02M 3/158

(52) U.S. Cl. CPC H02M 3/158
USPC 323/271

(57) ABSTRACT

A series-capacitor adaptively switched power conversion system includes, for example, a series-capacitor buck converter overlapping controller. The series-capacitor buck converter overlapping controller is arranged to provide reduced switching losses and improved system efficiency while the switched power conversion system is operating in a discontinuous conduction mode (DCM). While operating in the DCM, the series-capacitor buck converter overlapping controller generates precisely controlled frequency modulated waveforms that are adapted to independently drive control switches of one or more power converters. The series-capacitor buck converter overlapping controller is arranged to reduce (or eliminate) negative inductor current (and the associated conduction loss) that can be present in multiphase (two or more phases) series-capacitor buck converters.

### CLAIM OF PRIORITY

This application for patent claims priority to U.S. Provisional Application No. 61/841,770 entitled “A METHOD TO IMPROVE LIGHT LOAD EFFICIENCY IN MULTIPHASE SWITCHED CAPACITOR BUCK CONVERTERS” filed Jul. 1, 2013 in the United States Patent and Trademark Office, wherein the application listed above is hereby fully incorporated by reference herein for all purposes.

### BACKGROUND

Electronic circuits are designed using increasingly greater integration and/or smaller design features to attain increased processing power and/or increased portability. The demands of such electronic circuitry are often met by increasing the efficiency of power supplies. The efficiency of a switching power supply is dependent upon the timing of modulation signals that are used to control a power switching element of a power supply. However, the efficiency of the power supply is often affected by operating conditions (such as load) that are unknown (or not understood well) at the time of the design of the switching power and/or that vary in operation of the power supply. As the diversity of electronic circuit designs and applications increase, switching power supplies often require an increase in efficiencies in order to be able to meet or exceed increasingly strict operating requirements.

### SUMMARY

The problems noted above can be solved in a series-capacitor adaptively switched power conversion system that includes, for example, a series-capacitor buck converter overlapping controller. The series-capacitor buck converter overlapping controller 138 is arranged to provide reduced conduction losses and improved system efficiency while the switched power conversion system is operating in a discontinuous conduction mode (DCM). While operating in the DCM, the series-capacitor buck converter overlapping controller generates precisely controlled frequency modulated waveforms that are adapted to independently drive control switches of one or more power converters. The series-capacitor buck converter overlapping controller is arranged to reduce (or eliminate) negative inductor current (and the associated conduction loss) that can be present in multiphase series-capacitor buck converters.

This Summary is submitted with the understanding that it is not be used to interpret or limit the scope or meaning of the claims. Further, the Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an illustrative electronic device in accordance with example embodiments of the disclosure.

FIG. 2 is a waveform diagram illustrating current loads and switching waveforms of a conventional DCM multiphase buck converter.

FIG. 3 is a schematic diagram illustrating a conventional DCM multiphase series capacitor buck converter.

FIG. 4 is a waveform diagram illustrating negative circulating currents of a conventional DCM multiphase series capacitor buck converter.

FIG. 5 is a schematic of a series-capacitor buck converter multiphase controller in accordance with example embodiments of the disclosure.

FIG. 6 is a waveform diagram illustrating current loads and switching waveforms of a series-capacitor buck converter multiphase controller in accordance with example embodiments of the disclosure.

FIG. 7 is a waveform diagram illustrating alternative current loads and switching waveforms of a series-capacitor buck converter multiphase controller in accordance with example embodiments of the disclosure.

FIG. 8 is a schematic of a series-capacitor buck converter three-phase controller in accordance with example embodiments of the disclosure.

FIG. 9 is a waveform diagram illustrating current loads and switching waveforms of a series-capacitor buck converter three-phase controller in accordance with example embodiments of the disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be example of that embodiment, and not intended to intimate that the scope of the disclosure, including the claims, is limited to that embodiment.

Certain terms are used throughout the following description—and claims—to refer to particular system components. As one skilled in the art will appreciate, various names may be used to refer to a component or system. Accordingly, distinctions are not necessarily made herein between components that differ in name but not function. Further, a system can be a sub-system of yet another system. In the following discussion and in the claims, the terms “including” and “comprising” are used in an open-ended fashion, and accordingly are to be interpreted to mean “including, but not limited to . . . .” Also, the terms “coupled to” or “couples with” (and the like) are intended to describe either an indirect or direct electrical connection. Thus, if a first device couples to a second device, that connection can be made through a direct electrical connection, or through an indirect electrical connection via other devices and connections. The term “portion” can mean an entire portion or a portion that is less than the entire portion. The term “calibration” can include the meaning of the word “test.” The term “input” can mean either a source or a drain (or even a control input such as a gate where context indicates) of a PMOS (positive-type metal oxide semiconductor) or NMOS (negative-type metal oxide semiconductor) transistor. The term “pulse” can mean a portion of waveforms such as “squarewave” or “sawtooth” waveforms.

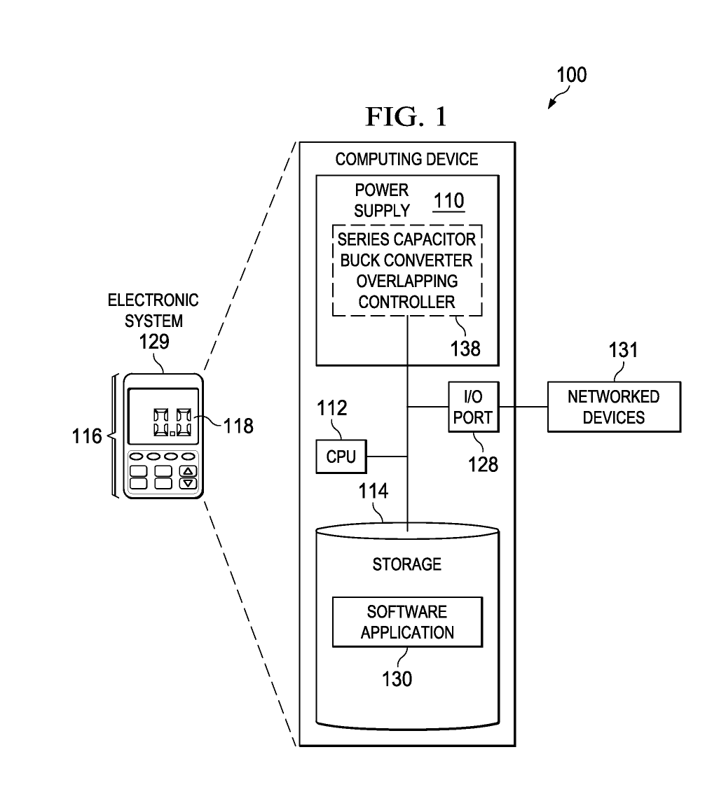

FIG. 1 shows an illustrative computing device 100 in accordance with preferred embodiments of the disclosure. For example, the computing device 100 is, or is incorporated into, an electronic system 129, such as a computer, electronics control “box” or display, communications equipment (including transmitters), or any other type of electronic system arranged to generate radio-frequency signals.

In some embodiments, the computing device 100 comprises a megacell or a system-on-chip (SoC) which includes control logic such as a CPU 112 (Central Processing Unit), a storage 114 (e.g., random access memory (RAM)) and a power supply 110. The CPU 112 can be, for example, a CISC-type (Complex Instruction Set Computer) CPU, RISC-type CPU (Reduced Instruction Set Computer), MCU-type (Microcontroller Unit), or a digital signal processor (DSP). The storage 114 (which can be memory such as on-processor cache, off-processor cache, RAM, flash memory, or disk storage) stores one or more software applications 130 (e.g., embedded applications) that, when executed by the CPU 112, perform any suitable function associated with the computing device 100.

The CPU 112 comprises memory and logic that store information frequently accessed from the storage 114. The computing device 100 is often controlled by a user using a UI (user interface) 116, which provides output to and receives input from the user during the execution the software application 130. The output is provided using the display 118, indicator lights, a speaker, vibrations, and the like. The input is received using audio and/or video inputs (using, for example, voice or image recognition), and electrical and/or mechanical devices such as keypads, switches, proximity detectors, gyros, accelerometers, and the like. The CPU 112 and power supply 110 is coupled to I/O (Input-Output) port 128, which provides an interface that is configured to receive input from (and/or provide output to) networked devices 131. The networked devices 131 can include any device (including test equipment) capable of point-to-point and/or networked communications with the computing device 100. The computing device 100 can also be coupled to peripherals and/or computing devices, including tangible, non-transitory media (such as flash memory) and/or cabled or wireless media. These and other input and output devices are selectively coupled to the computing device 100 by external devices using wireless or cabled connections. The storage 114 can be accessed by, for example, by the networked devices 131.

The CPU 112 is coupled to I/O (Input-Output) port 128, which provides an interface that is configured to receive input from (and/or provide output to) peripherals and/or computing devices 131, including tangible (e.g., “non-transitory”) media (such as flash memory) and/or cabled or wireless media (such as a Joint Test Action Group (JTAG) interface). These and other input and output devices are selectively coupled to the computing device 100 by external devices using wireless or cabled connections. The CPU 112, storage 114, and power supply 110 are also coupled to an external power supply (not shown), which is configured to receive power from a power source (such as a battery, solar cell, “live” power cord, inductive field, fuel cell, capacitor, and the like).

The power supply 110 comprises power generating and control components for generating power to enable the computing device 100 to executed the software application 130. For example, the power supply 110 provide one or more power switches, each of which can be independently controlled, that supply power at various voltages to various components of the computing device 100. The computing device 100 can operate in various power-saving modes wherein individual voltages are supplied (and/or turned off) in accordance with a selected power-saving mode and the components arranged within a specific power domain.

The power supply 110, for example, includes a series-capacitor buck converter overlapping controller 138. Although the series-capacitor buck converter overlapping controller 138 is illustrated as being included in the power supply 110 or as a single (e.g., logical) unit, various portions of the series-capacitor buck converter overlapping controller 138 can be included in the same module (e.g., as provided by a die as produced in semiconductor) or different modules.

The power supply 110 is a switched-mode power supply (e.g., “converter”) that alternately stores and outputs energy. Such converters typically receive either a DC or rectified AC voltage as an input voltage. Energy derived from the input voltage is temporarily stored in energy storage devices (such as an inductors and capacitors) during each switching cycle. Each switch in a group of power switches in the converter is actuated (e.g., turned on and/or off) to control the amount of energy that is output. A filter is normally used to reduce ripple in the output DC voltage and current. Depending on the topology of the converter, the output DC voltage can be higher or lower than the input voltages. The output DC voltage can also be inverted with respect to the input voltage.

Converters operate in either a discontinuous mode or a continuous mode. In the discontinuous mode, converters completely de-energize the energy storage devices before the end of every switching cycle. Accordingly, no current flows in the energy storage devices at the start of every switching cycle in the discontinuous mode. In the continuous mode, converters normally do not completely de-energize the energy storage devices before the end of every switching cycle. Accordingly, the current in the energy storage devices normally does not reach a point where current does not flow in the energy storage devices in the continuous mode.

The output of a converter is determined in part by the duty ratio. The duty ratio is the time period in which the switch is “on” divided by the time period of the switching cycle (such that D=Ton/Tp). The switching cycle time period is typically equal to the time period in which the switch is “on” plus the time period in which the switch is “off” (such that Tp=Ton+Toff). The output voltage of the buck converter is typically equal to the input voltage multiplied by the duty ratio (Vout=Vin*D).

For example, the power supply 110 is a multiphase series-capacitor (SC) buck converter that includes a series-capacitor buck converter overlapping controller 138. The series-capacitor buck converter overlapping controller 138 is arranged, for example, to provide reduced switching losses and improved system efficiency while operating in a discontinuous conduction mode (DCM). While operating in the DCM, the series-capacitor buck converter overlapping controller 138 is arranged to generate precisely controlled frequency modulated (e.g., by varying the pulse rate repetition frequency) waveforms that are adapted to independently drive control switches of one or more power converters. More particularly, the series-capacitor buck converter overlapping controller 138 is arranged to reduce (or eliminate) negative inductor current (and the associated conduction loss) present in conventional multiphase series-capacitor (SC) buck converters.

The discontinuous inductor current conduction mode (DCM) is a power mode that is used to improve light load efficiency in switching power converters. Because many computing devices 100 typically operate in applications that present electrical loads that are in the light-to-medium load current range, the light-load efficiency of voltage regulators has a substantial impact of the power efficiency of a system.

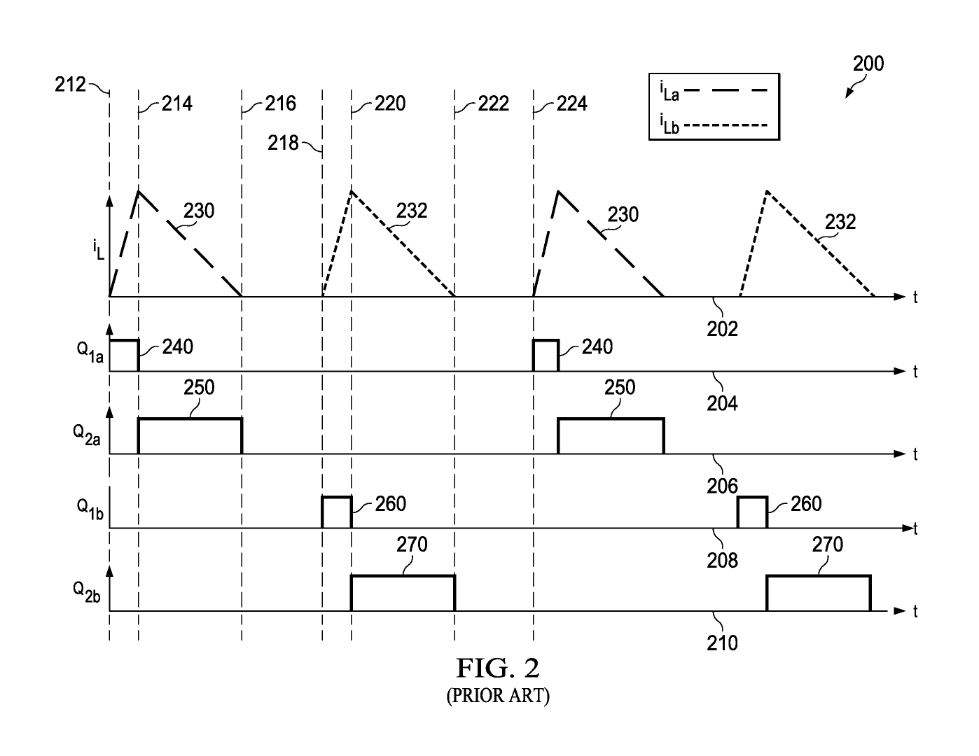

FIG. 2 is a waveform diagram illustrating current loads and switching waveforms of a conventional DCM multiphase buck converter. Generally described, waveform diagram 200 illustrates current load 202 and switching waveforms 204, 206, 208, and 210 that are used to control power switches that individually gate (e.g., switch on and off) selected portions of the current load signal202. The waveforms 204, 206, 208, and 210 are arranged to illustrate variations of the magnitude of the respective signal over time.

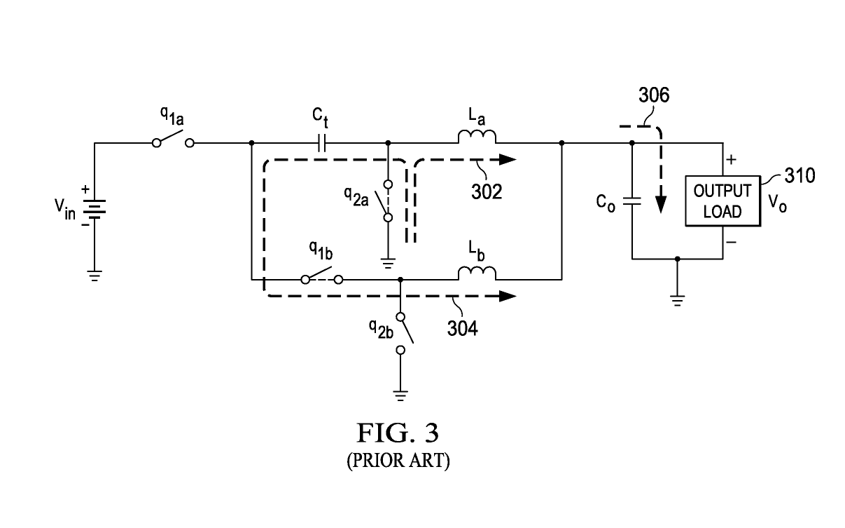

As illustrated, pulse 230 and pulse 232 are current load pulses of respective portions of the current load 202. Conventionally, pulse 230 and pulse 232 operate 180 degrees out of phase (with respect to each other). Pulse 230 is generated during a phase A (e.g., that is associated with a first inductor, described below with reference to FIG. 3) of a cycle and pulse 232 is generated during a phase B (e.g., that is associated with a second inductor, also described below with reference to FIG. 3) of the cycle. Accordingly, the phase operation is interleaved, having even-time spacing between the pulses used to gate pulses 230 and 232 in a periodic (e.g., repeating) fashion.

Pulse 240 (associated with a power switch Q₁ₐ) is used to control a rising edge of pulse 230 (that occurs between time 212 and 214 as well as subsequent cycles, such as a cycle that is initiated at time 224). Pulse 250 (associated with a power switch Q₂ₐ) is used to control a falling edge of pulse 230 (that occurs between time 214 and 216, as well as subsequent cycles). Pulse 260 (associated with a power switch Q_{1b}) is used to control a rising edge of pulse 232 (that occurs between time 218 and 220, as well as subsequent cycles). Pulse 270 (associated with a power switch Q_{2b}) is used to control a falling edge of pulse 232 (that occurs between time 220 and 222, as well as subsequent cycles). Accordingly, a subsequent cycle (e.g., that is subsequent to the cycle starting at time 212) begins at time 224.

FIG. 3 is a schematic diagram illustrating a conventional DCM multiphase series capacitor buck converter. Generally described, the circuit 300 includes a voltage source (such as a battery or capacitor bank) having a voltage input (Vᵢₙ), power switches Q₁ₐ, Q₂ₐ, Q_{1b}, and Q_{2b}, transfer capacitor Ct, inductor Lₐ (e.g., for storing power in phase A), inductor L_{b} (e.g., for storing power in phase B), and an output capacitor Cₒ, at which a voltage output is developed across output load 310. FIG. 2 and FIG. 3 are used to illustrate the operation of the converter 300.

In operation, the assertion (e.g., transitioning to a high state, which closes the power switch being controlled) of pulse 240 closes power switch Q₁ₐ at time 212, which couples power to a first terminal of inductor Lₐ via transfer capacitor Ct (while the other power switches, Q₂ₐ, Q_{1b}, and Q_{2b} remain open at time 212). Accordingly, the current (and flux) in inductor Lₐ begins to rise in accordance with the rising edge of pulse 230.

At time 214, the de-assertion (e.g., transitioning to a low state, which opens the power switch being controlled) of pulse 240 opens power switch Q₁ₐ, which decouples incoming power from inductor Lₐ. Also at time 214, the assertion of pulse 250 closes power switch Q₂ₐ, which couples the first terminal of inductor Lₐ to ground. Accordingly, the level of current in inductor Lₐ decreases as the level of stored flux (which generates current 302) of inductor Lₐ decreases. At time 216, the de-assertion of pulse 250 opens power switch Q₂ₐ, which decouples inductor Lₐ from ground.

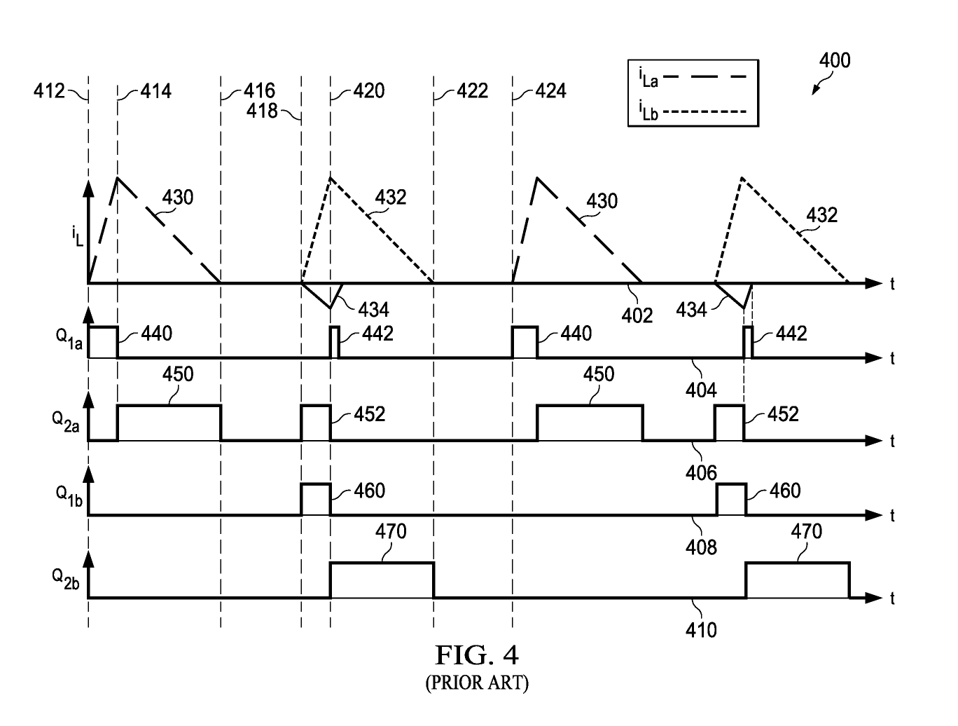

At time 218, the assertion of pulse 260 closes power switch Q_{1b}, which couples power to a first terminal of inductor L_{b}. Accordingly, the current (and flux) in inductor L_{b} begins to rise as illustrated by the rising edge of pulse 232. At time 220, the de-assertion of pulse 260 opens power switch Q_{1b}, which decouples incoming power from inductor L_{b}. Also at time 220, the assertion of pulse 270 closes power switch Q_{2b}, which couples the first terminal of inductor L_{b} to ground. Accordingly, the level of current in inductor L_{b} decreases as the level of stored flux of inductor L_{b} decreases. At time 222, the de-assertion of pulse 270 opens power switch Q₂ₐ, which decouples inductor L_{b} from ground. As discussed below in FIG. 4, the level (which typically varies in accordance with an operating conditions) of the output load 310 affects the degree to which internal power losses result from negative circulating currents in circuit 300.

FIG. 4 is a waveform diagram illustrating negative circulating currents of a conventional DCM multiphase series capacitor buck converter. Generally described, waveform diagram 400 illustrates current load 402 and switching waveforms 404, 406, 408, and 410 that are used to control power switches that individually gate (e.g., switch on and off) selected portions of the current load 402. The waveforms 404, 406, 408, and 410 are arranged to illustrate variations of the magnitude of the respective signal over time.

As illustrated, pulse 430 and pulse 432 are inductor current pulses of respective portions of the current load 402. Conventionally, pulse 430 and pulse 432 operate 180 degrees out of phase (with respect to each other). Pulse 430 is generated during a phase A of a cycle and pulse 432 is generated during a phase B of the cycle. Accordingly, the phase operation is interleaved, having even-time spacing between the pulses used to gate pulses 430 and 432 in a periodic (e.g., repeating) fashion. Conventional multiphase converters use an interleaving scheme that is arranged to control pulses to having a fixed phase shift, where the fixed phase shift is determined by the number of phases divided by 360 degrees (e.g., a two-phase converter has a fixed phase shift of 180 degrees whereas a three-phase converter has a fixed phase shift of 120 degrees).

Pulse 440 (associated with the power switch Q₁ₐ) is used to control a rising edge of pulse 430 (that occurs between time 412 and 414). Pulse 450 (associated with the power switch Q₂ₐ) is used to control a falling edge of pulse 430 (that occurs between time 414 and 416). Pulse 460 (associated with the power switch Q_{1b}) is used to control a rising edge of pulse 432 (that occurs between time 418 and 420). Pulse 470 (associated with the power switch Q_{2b}) is used to control a falling edge of pulse 432 (that occurs between time 420 and 422). Pulse 440 is asserted (e.g., again) at time 424, such that a subsequent cycle (that includes both phase A and phase B) is started.

When the circuit 300 is conventionally operated as a two-phase SC (series-capacitor) buck converter in conditions where the output load 310 presents a light-load level during light-load operation, additional losses are incurred. The additional losses include power loss resulting from the reverse current, illustrated by the reverse current pulse 434. The negative inductor current in phase A (e.g., when the phase A inductor current starts at zero and goes in a negative direction) normally occurs when switch Q₂ₐ (low side phase A) is turned on while switch Q_{1b} (high side phase B) is also turned on. For example, the reverse current pulse 434 occurs on when the high side on-time of phase B (e.g., during the assertion of pulse 460) has not concluded before the inductor current in phase A (e.g., in inductor Lₐ) has reached zero. Accordingly, the negative inductor current in phase A can occur more frequently during light-load conditions as a result of less energy being drained by the load from inductor Lₐ).

In this two-phase operation, the low side switch (e.g., transistor Q₂ₐ) coupled to the input of inductor Lₐ can effectively be closed at during the period between time 418 and time 420. The low side switch can be closed by a body diode effect (notwithstanding the lack of the assertion of a control signal at the control input of the low side switch). When transistor Q₂ₐ is a MOSFET transistor, turning transistor Q₂ₐ on causes reverse current from inductor Lₐ. The reverse current pulse 434 is coupled by the high side switch (e.g., transistor Q_{1b}) to inductor L_{b} is when the low side switch closed during phase B (e.g., at time 420).

When the inductor flux energy in phase A (e.g., in inductor Lₐ) has not reached zero before the high side on-time of phase B (e.g., during the assertion of pulse 460) is initiated, the inductor current reverses to generate a negative current pulse 434. The negative current pulse 434 is coupled from ground (as the reverse of current 302) in accordance with the body-current pulse 452 at time 418 and is coupled to voltage input in accordance with the body-current pulse 442. This negative circulating current 304 subtracts from energy otherwise provided to the output (e.g., current 306) and decreases efficiency of the circuit 300. The negative circulating current 304 does not normally occur while operating in continuous conduction mode (CCM), but is a source of power loss (when the negative circulating current 304 exists) during discontinuous conduction mode (DCM).

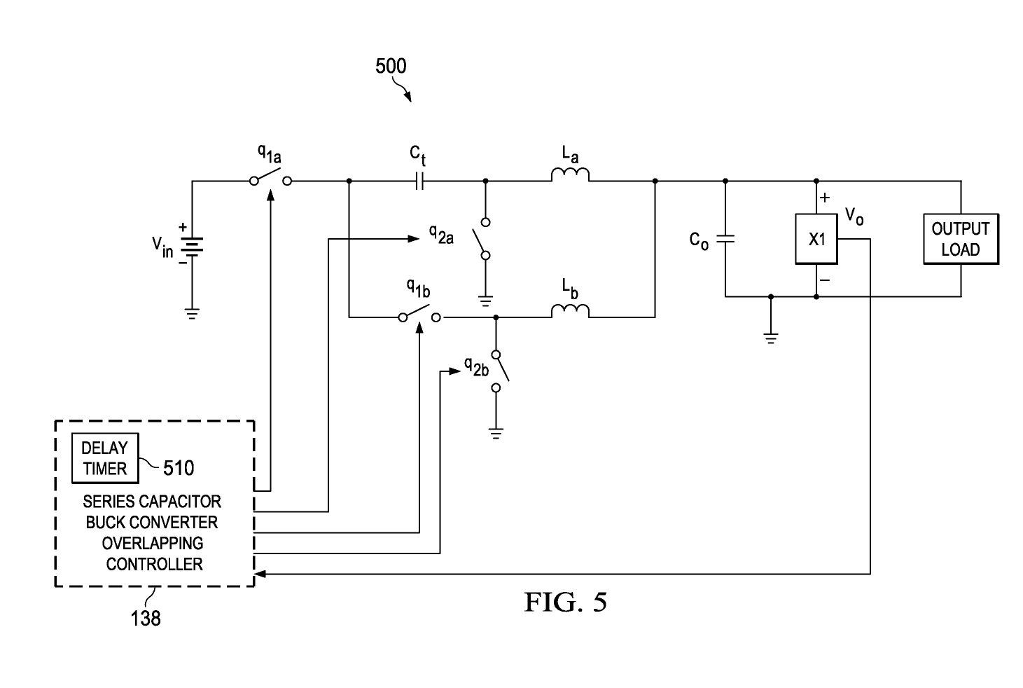

FIG. 5 is a schematic of a series-capacitor buck converter multiphase controller in accordance with example embodiments of the disclosure. Generally described, the converter 500 includes a voltage source (such as a battery or capacitor bank) having a voltage input (Vᵢₙ), power switches Q₁ₐ, Q₂ₐ, Q_{1b}, and Q_{2b}, transfer capacitor Ct, inductor Lₐ (e.g., for storing power in phase A), inductor L_{b} (e.g., for storing power in phase B), and an output capacitor Cₒ, at which a voltage output is developed across output load 310. The converter 500 includes a series-capacitor buck converter overlapping controller 138 that is arranged to reduce, if not eliminate, negative circulating currents that result from series-capacitor buck converter topology of turning power switch Q₂ₐ on while power switch Q_{1b} is turned on as described above.

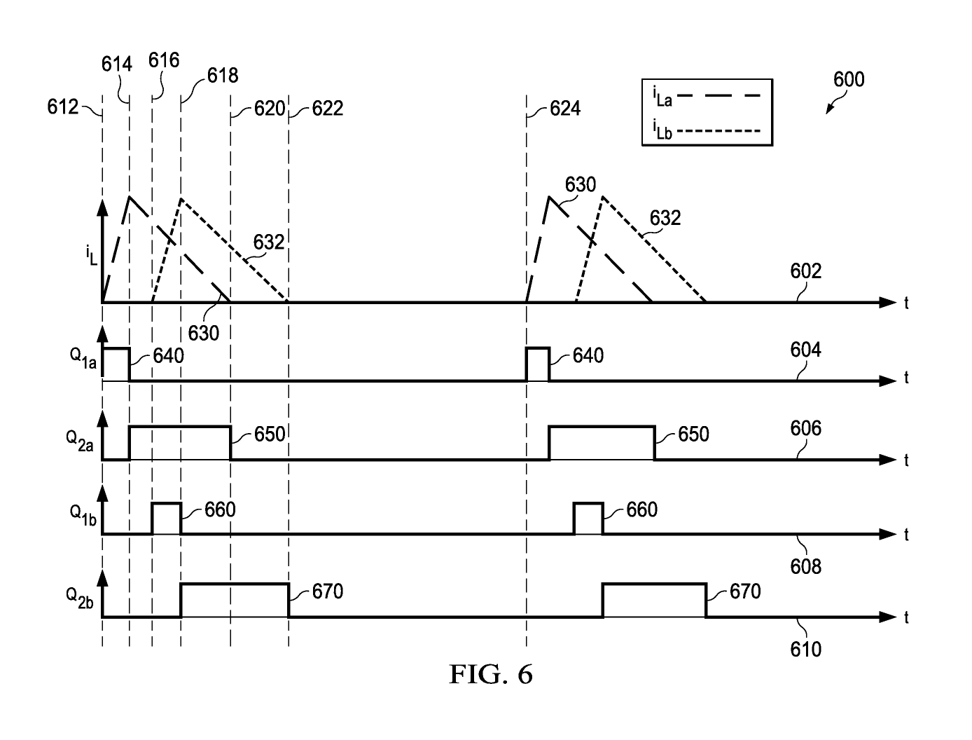

The controller 138 is coupled to an output of sensor X1. The sensor X1 is arranged to monitor one or more output parameters (e.g., such as voltage, power, current, and combinations thereof) of converter 500 and to generate output control signals in response to the monitored feedback signal. Accordingly, the controller 138 is arranged in a feedback loop configuration to frequency modulate (e.g., adjust the pulse repetition frequency of) the power switches power switches Q₁ₐ, Q₂ₐ, Q_{1b}, and Q_{2b} in response to the monitored output parameter. The controller 138 is arranged with output control signals where each output control signal is arranged to selectively and independently controlling a respective one of the power switches power switches Q₁ₐ, Q₂ₐ, Q_{1b}, and Q_{2b}. As described below with respect to FIG. 6, the controller 138 includes a delay timer 510 for controlling a degree of overlap (e.g., phase shift) between the phase A control signals and the phase B control signals (other embodiments of the controller 138 are possible such as state machines, programmable delay lines, and the like).

The controller 138 is arranged to modulate the frequency of the pulses (e.g., pulse frequency modulation, or “PFM”) used to control the power switches. For example, the pulse repetition frequency (PRF) can be increased as desired to regulate the output voltage as load demand increases (e.g., as measured in operation by sensor X1). Similarly, the pulse repetition frequency modulation, can be reduced (e.g., in periods of time when operating under reduced output loads) to reduce power loss while still regulating the output voltage.) The operation of converter 500 is discussed below with respect to FIG. 6.

FIG. 6 is a waveform diagram illustrating current loads and switching waveforms of a series-capacitor buck converter multiphase controller in accordance with example embodiments of the disclosure. Generally described, waveform diagram 600 illustrates current load 602 and switching waveforms 604, 606, 608, and 610 that are used to control power switches that individually gate (e.g., switch on and off) selected portions of the current load 602.

The waveforms 604, 606, 608, and 610 are arranged to illustrate variations of the magnitude of the respective signal over time. Each of the waveforms 604, 606, 608, and 610 is selectively and independently controlled by controller 138, for example. Each such waveform is arranged to control a respective one of the power switches power switches Q₁ₐ, Q₂ₐ, Q_{1b}, and Q_{2b}. such that the negative circulating currents that result from series-capacitor buck converter topology of turning power switch Q₂ₐ on while power switch Q_{1b} is turned on are reduced, if not eliminated, by adjusting a degree of overlap of power signals (e.g., pulses) that are generated by the power switches. Accordingly, the power switches are arranged to provide “shots” of energy (e.g., as indicated by pulses 630 and 632) to the output without any circulating current power losses.

In various embodiments, the converter 138 is arranged to control the degree of overlap of pulse 630 and pulse 632 in response to programming commands from a processor (e.g., CPU 112) and/or in response to a feedback signal from the output sensor X1. Also in various embodiments, the converter 138 is arranged to control the pulse repetition frequency in response to programming commands from a processor and/or in response to a feedback signal from the output sensor X1. The amount of delay (such as the setting of delay timer 510) is optionally selected (and/or adjusted) dependent upon a power operating mode of the processor (and/or system of the processor), such as one of: active mode, battery mode, sleep mode, suspend mode, hibernate mode, deep sleep mode, and the like. Accordingly, the overlapping of phase A and B can be initiated or adjusted in accordance with that particular mode being selected and/or transitioning from a first power mode to a second power mode that consumes less power. Additionally, the overlapping of phase A and B can be terminated or adjusted in accordance with that particular mode being selected and/or transitioning from the second power mode to the first power mode.

The pulse 630 and pulse 632 are “inductor current pulses” of respective sources that contribute power to the current load 602. The pulse 630 and the pulse 632 are overlapped with respect to each other. The degree of overlap between pulse 630 and pulse 632 affects the degree to which negative circulating currents may occur when closing (e.g., activating) the high side phase B power switch (Q_{1b}) before the energy stored in the phase A inductor (I_{1b}) is exhausted. Pulse 630 rises when transistor Q₁ₐ is turned on and falls when Q₂ₐ, is turned on. Similarly, pulse 632 rises when transistor Q_{1b} is turned on and falls when Q_{2b} is turned on. In the example, transistor Q_{1b} is turned on while transistor Q₂ₐ is turned on. Transistor Q₂ₐ is normally turned on before the current in the phase A inductor (I₁ₐ) has reached zero.

The degree of overlap of pulse 630 and pulse 632 is controlled by delaying the closing of power switches Q_{1b}, and Q_{2b} with respect to the closing of power switch Q₂ₐ, Typically, the delay (e.g., in time between the pulses used to gate pulses 630 and 632) is repeated in a periodic repeating fashion. In various embodiments the amount of delay (e.g., spacing in time) is fixed or variable (e.g., a fixed delay plus a variable delay) responsive to operating conditions such as the magnitude of power consumption by the output load, voltage level, voltage ripple, and the like.

Accordingly, pulse 640 (associated with the power switch Q₁ₐ) is used to control a rising edge of the pulse 630 (which occurs between time 612 and 614). Pulse 650 (associated with the power switch Q₂ₐ) is used to control a falling edge of pulse 630 (which occurs between time 614 and 620). Pulse 660 (associated with the power switch Q_{1b}) is used to control a rising edge of pulse 632 (that occurs between time 616 and 618). Pulse 670 (associated with the power switch Q_{2b}) is used to control a falling edge of pulse 632 (that occurs between time 618 and 622). Pulse 640 is asserted (e.g., again) at time 624, such that a subsequent cycle (that includes both phase A and phase B) is started.

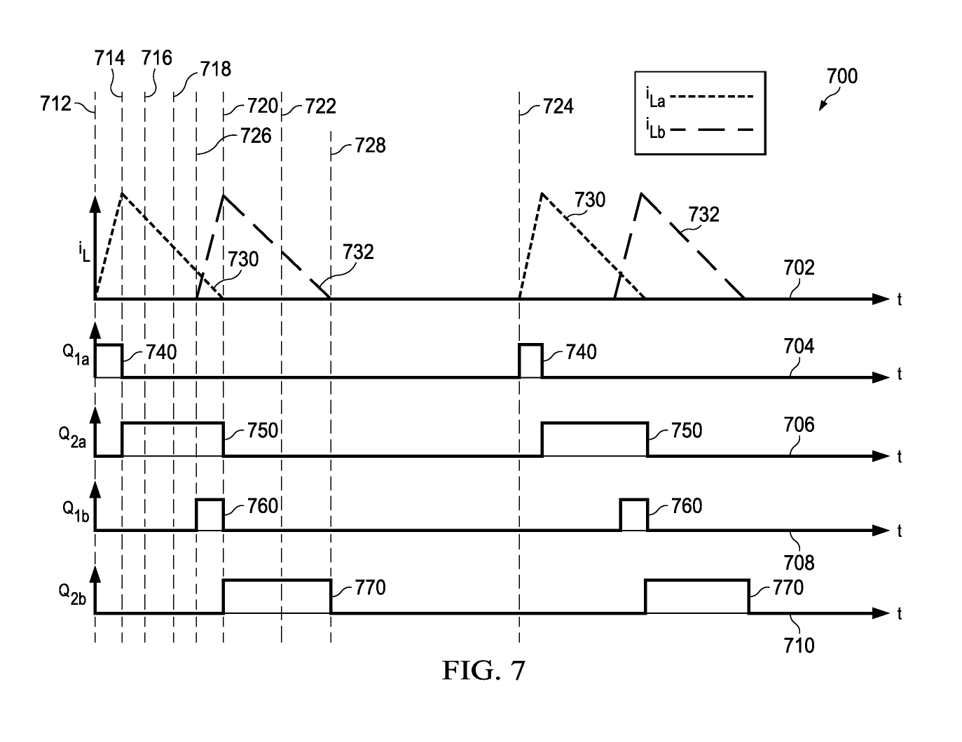

The high side on-time of phase B (e.g., the width of pulse 660) is less than the low side on-time of phase A (e.g., the width of pulse 650) so there is flexibility in the timing of the assertion of pulse 660. In the example illustrated in FIG. 6, the high side of phase B (e.g., the rising edge of pulse 660) can be turned on shortly after (e.g., in response to) the high side of phase A (e.g., the falling pulse 640) turning off. Similarly, the high side of phase B (e.g., the rising edge of pulse 660) can be turned on shortly after (e.g., in response to) the low side of phase A (e.g., the rising edge of pulse 650) is turning on. The efficiency of the operation in accordance with waveform diagram 600 can be enhanced as described with reference to FIG. 7.

FIG. 7 is a waveform diagram illustrating alternative current loads and switching waveforms of a series-capacitor buck converter multiphase controller in accordance with example embodiments of the disclosure. Generally described, waveform diagram 700 illustrates current load 702 and switching waveforms 704, 706, 708, and 710 that are used to control power switches that individually gate (e.g., turn on and off) selected portions of the current load 702.

The waveforms 704, 706, 708, and 710 are arranged to illustrate variations of the magnitude of the respective signal over time. Each of the waveforms 704, 706, 708, and 710 is selectively and independently controlled by controller 138, for example. In various embodiments, the converter 138 is arranged to control the degree of overlap of pulse 730 and pulse 732 in response to programming commands from a processor (e.g., CPU 112) and/or in response to a feedback signal from the output sensor X1. Also in various embodiments, the converter 138 is arranged to control the pulse repetition frequency in response to programming commands from a processor and/or in response to a feedback signal from the output sensor X1.

The pulse 740 (associated with the power switch Q₁ₐ) is used to control a rising edge of the pulse 730 (which occurs between time 712 and 714). Pulse 750 (associated with the power switch Q₂ₐ) is used to control a falling edge of pulse 730 (which occurs between time 714 and 720). Pulse 760 (associated with the power switch Q_{1b}) is used to control a rising edge of pulse 732 (that occurs between time 726 and 720). Pulse 770 (associated with the power switch Q_{2b}) is used to control a falling edge of pulse 732 (that occurs between time 720 and 728). Pulse 740 is asserted (e.g., again) at time 724, such that a subsequent cycle (that includes both phase A and phase B) is started.

The high side on-time of phase B (e.g., the width of pulse 760) is less than the low side on-time of phase A (e.g., the width of pulse 750) so there is flexibility in the timing of the assertion of pulse 760. In the example illustrated in FIG. 7, the high side of phase B (e.g., which includes the rising edge of pulse 760) can be turned on a delay period that starts after (e.g., in response to) the high side of phase A (e.g., which includes the falling pulse 740) turning off. The delay period is short enough such that the high side of phase B (e.g., which includes the falling edge of pulse 760) is turned off before the low side of phase A (e.g., which includes the falling edge of pulse 750) is turned off.

Accordingly, the timing delay is adjusted (e.g., in response to the feedback signal from sensor X1, the value of delay timer 510, and combinations thereof) in such a way such that the high side on-time of phase B occurs at the end of the low side on-time of phase A. This approach reduces the output voltage ripple and the RMS current in the low side of phase A.

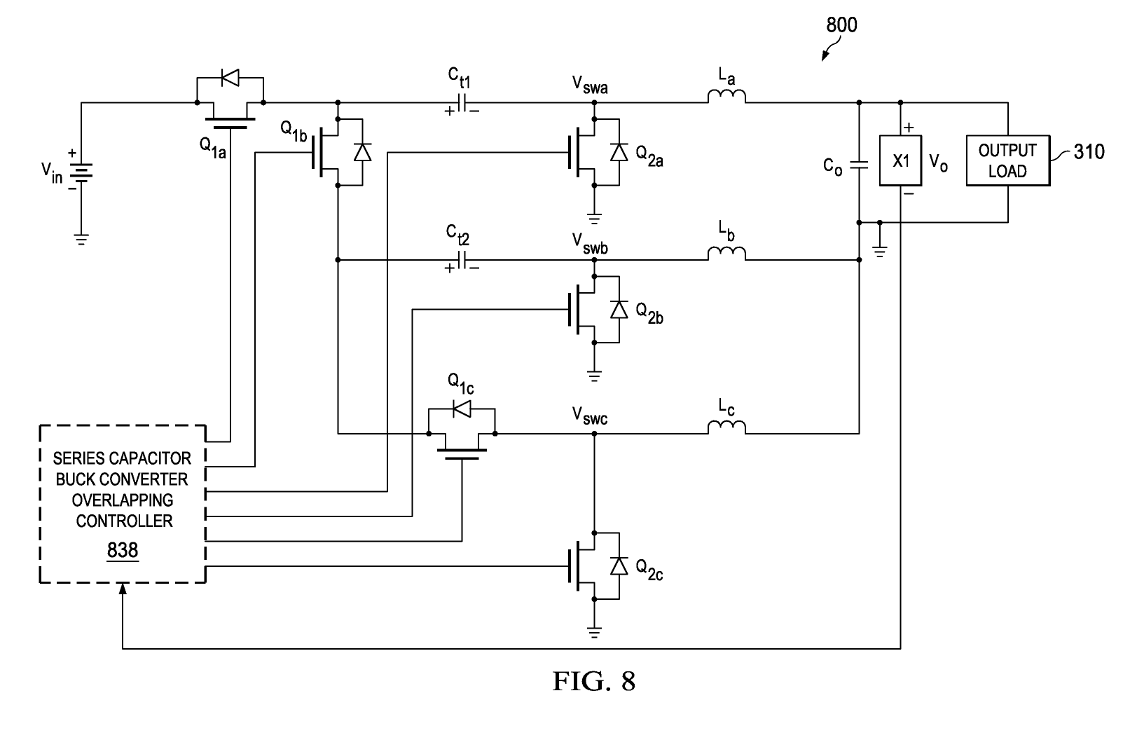

FIG. 8 is a schematic of a series-capacitor buck converter three-phase controller in accordance with example embodiments of the disclosure. Generally described, the converter 800 includes a voltage source (such as a battery or capacitor bank) having a voltage input (Vᵢₙ), power switches Q₁ₐ, Q_{1b}, Q_{1c}, Q₂ₐ, Q_{2b}, and Q_{2c}, transfer capacitor Ct1, transfer capacitor Ct2, inductor Lₐ (e.g., for storing power in phase A), inductor L_{b} (e.g., for storing power in phase B), inductor L_{c} (e.g., for storing power in phase C), and an output capacitor Cₒ, at which a voltage output is developed across output load 310. The converter 800 includes a series-capacitor buck converter overlapping controller 138 that is arranged to reduce, if not eliminate, negative circulating currents that result from series-capacitor buck converter topology of turning power switch Q₂ₐ on while power switch Q_{1b} is turned on as described above or turning power switch Q_{2b} on while power switch Q_{1c} is turned on.

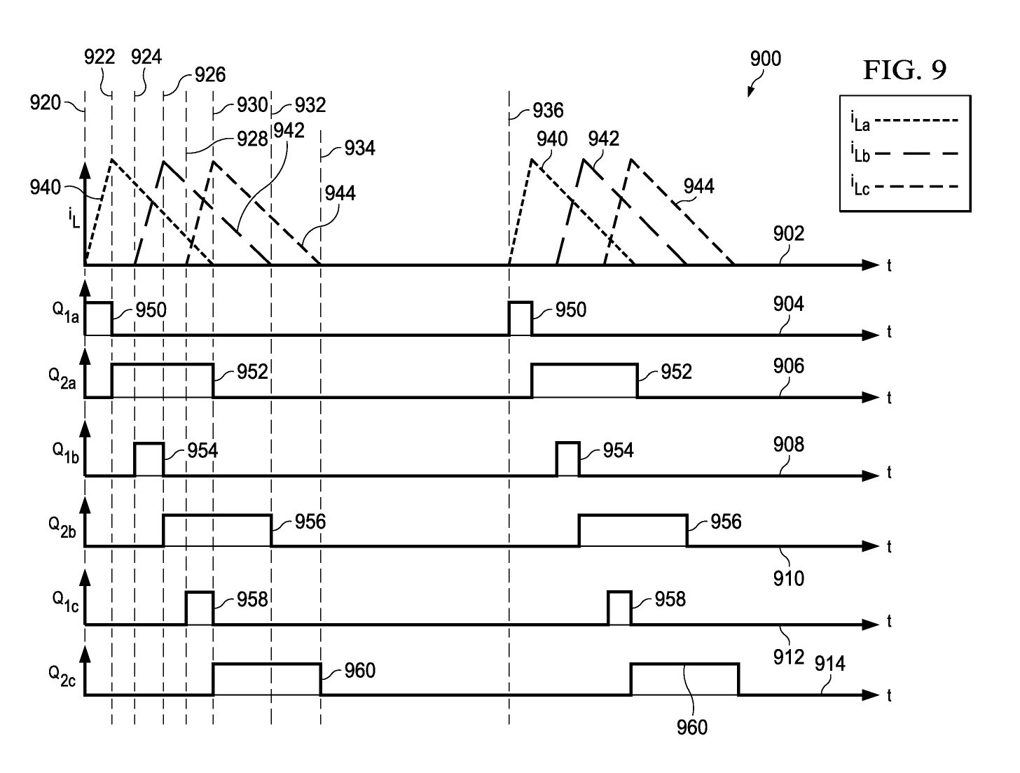

The controller 838 is a controller such as controller 138 and is coupled to an output of sensor X1. The sensor X1 is arranged to monitor one or more output parameters (e.g., such as voltage, power, current, and combinations thereof) of converter 800 and to generate output control signals in response to the monitored feedback signal. Accordingly, the controller 138 is arranged in a feedback loop configuration to frequency modulate (e.g., adjust the pulse repetition frequency of) the power switches power switches Q₁ₐ, Q_{1b}, Q_{1c}, Q₂ₐ, Q_{2b}, and Q_{2c}, in response to the monitored output parameter. The controller 138 is arranged with output control signals where each output control signal is arranged to selectively and independently controlling a respective one of the power switches power switches Q₁ₐ, Q_{1b}, Q_{1c}, Q₂ₐ, Q_{2b}, and Q_{2c}. The operation of converter 800 is discussed below with respect to FIG. 9.

FIG. 9 is a waveform diagram illustrating current loads and switching waveforms of a series-capacitor buck converter multiphase controller in accordance with example embodiments of the disclosure. Generally described, waveform diagram 900 illustrates current load 902 and switching waveforms 904, 906, 908, 910, 912, and 914 that are used to control power switches that individually gate (e.g., switch on and off) selected portions of the current load 902.

The waveforms 904, 906, 908, 910, 912, and 914 are arranged to illustrate variations of the magnitude of the respective signal over time. Each of the waveforms 904, 906, 908, and 910 is selectively and independently controlled by controller 838, for example. Each such waveform is arranged to control a respective one of the power switches power switches Q₁ₐ, Q_{1b}, Q_{1c}, Q₂ₐ, Q_{2b}, and Q_{2c}. such that the negative circulating currents that result from series-capacitor buck converter topology of turning power switch Q₂ₐ on while power switch Q_{1b} is turned on (or turning power switch Q_{2b} on while power switch Q_{1c} is turned on) are reduced, if not eliminated, by adjusting a degree of overlap of power signals (e.g., pulses) that are generated by the power switches. Accordingly, the power switches are arranged to provide “shots” of energy (e.g., as indicated by pulses 940, 942, and 944) to the output without any circulating current power losses.

In various embodiments, the converter 838 is arranged to control the degree of overlap of pulse 940, pulse 942, and pulse 944 in response to programming commands from a processor (e.g., CPU 112) and/or in response to a feedback signal from the output sensor X1. Also in various embodiments, the converter 838 is arranged to control the pulse repetition frequency in response to programming commands from a processor and/or in response to a feedback signal from the output sensor X1. The amount of delay (such as the setting of one or more delay timers 510) is optionally selected (and/or adjusted) dependent upon a power operating mode of the processor (and/or system of the processor), such as one of: active mode, battery mode, sleep mode, suspend mode, hibernate mode, deep sleep mode, and the like. Accordingly, the overlapping of phases A, B, and C can be initiated or adjusted in accordance with that particular mode being selected and/or transitioning from a first power mode to a second power mode that consumes less power. Additionally, the overlapping of phases A, B, and C can be terminated or adjusted in accordance with that particular mode being selected and/or transitioning from the second power mode to the first power mode. In view of the disclosure herein, it can be seen that the disclosed techniques and methods can be applied to two-, three-, four-, or more-phase systems.

The pulse 940, pulse 942, and 944 are “inductor current pulses” of respective sources that contribute power to the current load 902. The pulse 940, pulse 942, and pulse 944 are overlapped with respect to each other. The degree of overlap between pulse 940, pulse 942, and pulse 944 affects the degree to which negative circulating currents may occur when closing (e.g., activating) the high side phase B power switch (Q_{1b}) before the energy stored in the phase A inductor (I_{La}) is exhausted (or activating the high side phase C power switch before the energy stored in the phase B is exhausted). Pulse 940 rises when transistor Q₁ₐ is turned on and falls when Q₂ₐ, is turned on. Similarly, pulse 942 rises when transistor Q_{1b} is turned on, and falls when Q_{2b} is turned on. Likewise, pulse 944 rises when transistor Q_{1c} is turned on, and falls when Q_{2c} is turned on. In the example, transistor Q_{1b} is turned on while transistor Q₂ₐ is turned on and transistor Q_{1c} is turned on while transistor Q_{2b} is turned on. Transistor Q₂ₐ is normally turned on before the current in the phase A inductor (I_{La}) has reached zero and transistor Q_{2b} is normally turned on before the current in the phase B inductor (I_{Lb}) has reached zero.

The degree of overlap of pulse 940 and pulse 932 is controlled by delaying the closing of power switches Q_{1b}, and Q_{2b} with respect to the closing of power switch Q₂ₐ. Similarly, the degree of overlap of pulse 942, and pulse 944 is controlled by delaying the closing of power switches Q_{1c}, and Q_{2c} with respect to the closing of power switch Q_{2b}. Typically, the delay (e.g., in time between the pulses used to gate pulses 940 and 942 and pulses 942 and 944) is repeated in a periodic repeating fashion. In various embodiments the amount of delay (e.g., spacing in time) is fixed or variable (e.g., a fixed delay plus a variable delay) responsive to operating conditions such as the magnitude of power consumption by the output load, voltage level, voltage ripple, and the like.

Accordingly, pulse 950 (associated with the power switch Q₁ₐ) is used to control a rising edge of the pulse 940 (which occurs between time 920 and 922). Pulse 952 (associated with the power switch Q₂ₐ) is used to control a falling edge of pulse 940 (which occurs between time 922 and 930). Pulse 954 (associated with the power switch Q_{1b}) is used to control a rising edge of pulse 942 (that occurs between time 924 and 926). Pulse 956 (associated with the power switch Q_{2b}) is used to control a falling edge of pulse 942 (that occurs between time 926 and 932). Pulse 958 (associated with the power switch Q_{1c}) is used to control a rising edge of pulse 944 (that occurs between time 928 and 30). Pulse 960 (associated with the power switch Q_{2c}) is used to control a falling edge of pulse 944 (that occurs between time 930 and 934). Pulse 940 is asserted (e.g., again) at time 936, such that a subsequent cycle (that includes all phases A, B, and C) is started.

In an embodiment, a controller (e.g., such as a microcontroller or a digital signal processor) is used to control one or more attributes of the switching waveforms 904, 906, 908, 910, 912, and 914, the thresholds of controller 138 with respect to feedback response to the feedback signal from sensor X1, and other system level controlled variables such as power mode selection and power mode transitioning. The variables are software programmable, which allows more flexibility for implementing the disclosed control schemes and provides an enhanced ability to adaptively adjust to dynamically changing conditions for optimized system performance.

In various embodiments, the above described components can be implemented in hardware or software, internally or externally, and share functionality with other modules and components as illustrated herein. For example, the controller 138 can be implemented outside of a device and/or substrate upon which the inductor Lₐ, inductor L_{b}, and inductor L_{c} reside.

The various embodiments described above are provided by way of illustration only and should not be construed to limit the claims attached hereto. Those skilled in the art will readily recognize various modifications and changes that could be made without following the example embodiments and applications illustrated and described herein, and without departing from the true spirit and scope of the following claims.

What is claimed is:

1. A converter, comprising:
a first phase energy storage device for charging and discharging power responsive to a high side first phase power switch and a low side first phase power switch;
a second phase energy storage device for charging and discharging power responsive to a high side second phase power switch and a low side second phase power switch; and
a controller for controlling the high side first phase power switch and the low side first phase power switch, for controlling the high side second phase power switch and the low side second phase power switch, and for controlling the charging of the second phase energy storage device during at least a portion of time in which the first phase energy device is being discharged responsive to at least one of the high side first phase power switch and the low side first phase power switch.

2. The converter of claim 1, wherein the controller is arranged to close the high side second phase power switch while the first phase energy storage device stores power.

3. The converter of claim 1, wherein the controller is arranged to close the high side second phase power switch while the first phase energy storage device stores power.

4. The converter of claim 3, comprising a series capacitor having a first terminal that is coupled to a first terminal of the first phase energy storage device, wherein the high side first phase power switch has a first terminal that is coupled to a second terminal of the series capacitor and a second terminal that is coupled to a voltage input, and wherein the low side first phase power switch has a first terminal that is coupled to the first terminal of the first phase energy storage device and a second terminal that is coupled to ground.

5. The converter of claim 4, wherein the high side second phase power switch has a first terminal that is coupled to the second terminal of the series capacitor and a second terminal that is coupled to a first terminal of the second phase energy storage device, wherein the second phase energy storage device has a second terminal that is coupled to a second terminal of the first phase energy storage device, and wherein the low side second phase switch has a first terminal that is coupled to the first terminal of the second phase energy storage device and a second terminal that is coupled to ground.

6. The converter of claim 4 wherein the high side second switch is transitioned to a closed state while the high side first phase power switch is in an open state and the low side first phase power switch is in a closed state.

7. The converter of claim 4, wherein the high side second phase power switch is transitioned from the closed state to an open state while the low side second phase power switch is in a closed state.

8. The converter of claim 7, wherein high side second phase power switch is transitioned from the closed state to an open state while the low side second phase power switch is in an open state.

9. The converter of claim 8, wherein high side second phase power switch is transitioned from the closed state to an open state while the low side second phase power switch is being transitioned from a closed state to an open state.

10. The converter of claim 1, wherein the converter is arranged to reduce negative circulating charges by charging of the second phase energy storage device during at least a portion of time in which the first phase energy device is being discharged.

11. The converter of claim 10, wherein the controller is arranged to select a delay time for the start of the charging of the second energy storage device in response to the selection of a first system power mode in which less power is consumed than a second system power mode in which more power is consumed.

12. The converter of claim 1, comprising a third phase energy storage device for charging and discharging power responsive to a high side third phase power switch and a low side third phase power switch, wherein the controller is arranged for controlling the charging of the third phase energy storage device during at least a portion of time in which the second phase energy device is being discharged responsive to at least one of the high side second phase power switch and the low side second phase power switch.

13. The converter of claim 12, wherein the wherein the controller is arranged for controlling the charging of the third phase energy storage device during at least a portion of time in which the first phase energy device is being discharged responsive to at least one of the high side first phase power switch and the low side first phase power switch.

14. A processing system, comprising:
a processor; and
a power converter arranged to provide power to the processor, the power converter comprising: a first phase energy storage device for charging and discharging power responsive to a high side first phase power switch and a low side first phase power switch; a second phase energy storage device for charging and discharging power responsive to a high side second phase power switch and a low side second phase power switch; and a controller for controlling the high side first phase power switch and the low side first phase power switch, for controlling the high side second phase power switch and the low side second phase power switch, and for controlling the charging of the second phase energy storage device during at least a portion of time in which the first phase energy device is being discharged responsive to at least one of the high side first phase power switch and the low side first phase power switch.

15. The system of claim 14, wherein the processor is arranged to operate in a first system power mode in which less power is consumed than a second system power mode in which more power is consumed, and wherein a value for a delay time for the start of the charging of the second energy storage device is applied in response to a selection of the first system power mode.

16. The system of claim 15, comprising one or more additional phase energy storage devices for charging and discharging power in a respective inductor responsive to a high side respective phase power switch and a low side respective phase power switch, wherein the one or more additional phase energy storage devices are in addition to the first and second phase energy storage devices, and wherein the controller is arranged for controlling the charging of the one or more additional phase energy storage devices during at least a portion of time in which the second phase energy device is being discharged responsive to at least one of the high side second phase power switch and the low side second phase power switch.

17. A method of power conversion, comprising:
charging and discharging power in a first phase energy storage device in response to actuation of a high side first phase power switch and actuation of a low side first phase power switch;
charging and discharging power in a second phase energy storage device in response to a high side second phase power switch and a low side second phase power switch; and
controlling the charging of the second phase energy storage device during at least a portion of time in which the first phase energy device is being discharged responsive to at least one of the high side first phase power switch and the low side first phase power switch.

18. The method of claim 17, wherein the second phase energy storage device is at least partially charged using current supplied by the first phase energy storage device.

19. The method of claim 18, wherein current supplied by the first phase energy storage device to charge the second phase energy storage device is coupled from the phase energy storage device to the second phase energy storage device via a first transfer capacitor.

20. The method of claim 18, comprising coupling current from the second phase energy storage device to a third phase energy storage device via a second transfer capacitor.
